(19) United States
(12) Patent Application Publication
(10) Pub. No.: US 2026/0296009 A1
(43) Pub. Date: Oct. 1, 2026

(54) LIQUID EJECTING HEAD AND LIQUID EJECTING APPARATUS

(71) Applicant: SEIKO EPSON CORPORATION, Tokyo (JP)

(72) Inventors: Yu SHIOZAWA, MINAMIMINOWA- MURA (JP); Takahiro KANEGAE, SHIOJIRI-SHI (JP); Nobuaki ITO, SUWA-SHI (JP)

(21) Appl. No.: 19/574,540

(22) Filed: Mar. 23, 2026

(30) Foreign Application Priority Data
Mar. 25, 2025 (JP) 2025-050817

(51) Int. Cl. B41J 2/14; B41J 2/175; B41J 2/19

(52) U.S. Cl. CPC B41J 2/14233; B41J 2/1433; B41J 2/175; B41J 2/19; B41J 2002/14419; B41J 2202/07; B41J 2202/11

(57) ABSTRACT

When a flow path resistance of the pressure chamber is referred to as Rcav, a flow path resistance of the supply-side throttle portion is referred to as Rin_res, a flow path resistance of the discharge-side throttle portion is referred to as Rout_res, a flow path resistance of a portion of the individual supply flow path other than the supply-side throttle portion is referred to as Rin_oth, and a flow path resistance of a portion of the individual discharge flow path other than the discharge-side throttle portion is referred to as Rout_oth, Rcav < Rin_res, Rcav < Rout_res, Rin_oth < Rin_res, and Rout_oth > Rout_res are satisfied.

The present application is based on, and claims priority from JP Application Serial Number 2025-050817, filed Mar. 25, 2025, the disclosure of which is hereby incorporated by reference herein in its entirety.

### BACKGROUND

### 1. Technical Field

The present disclosure relates to a liquid ejecting head and a liquid ejecting apparatus that eject a liquid, and particularly to an ink jet recording head and an ink jet recording apparatus that eject an ink as a liquid.

### 2. Related Art

A liquid ejecting apparatus typified by an ink jet type printer or a liquid ejecting apparatus such as a plotter includes a liquid ejecting head which can eject a liquid such as an ink stored in a cartridge or a tank as a droplet. The liquid ejecting head includes a nozzle that ejects the liquid, a pressure chamber that communicates with the nozzle, and an energy generation element that generates a pressure fluctuation in the liquid in the pressure chamber, and ejects the droplet from the nozzle by generating the pressure fluctuation in the liquid in the pressure chamber by the energy generation element. In addition, there is a so-called circulation type liquid ejecting head that supplies and discharges a liquid to and from a pressure chamber (for example, see JP-A-2023-72166).

In the circulation type liquid ejecting head as in JP-A-2023-72166, since a nozzle communicates directly below the pressure chamber, air bubbles or thickened ink in the pressure chamber can be preferably discharged while improving ejection efficiency, and high recovery performance can be provided.

In the circulation type liquid ejecting head as disclosed in JP-A-2023-72166, it is necessary to provide a supply-side throttle portion and a discharge-side throttle portion having a large flow path resistance on each of the supply-side and the discharge-side of the pressure chamber. Since the nozzle, an individual supply flow path, and an individual discharge flow path communicate with the pressure chamber, when the supply-side throttle portion and the discharge-side throttle portion are not provided, a pressure toward the nozzle is reduced even when the pressure chamber is pressurized by an energy generation element, and there is a problem that an ejection characteristic of a droplet from the nozzle, that is, a flight speed and a weight of the droplet are reduced. The present disclosure aims to optimize a flow path resistance of the individual supply flow path including the supply-side throttle portion and the individual discharge flow path including the discharge-side throttle portion.

### SUMMARY

According to an aspect of the present disclosure, there is provided a liquid ejecting head including: a pressure chamber that applies a pressure to a liquid inside the pressure chamber; a nozzle that ejects the liquid by the pressure of the pressure chamber; an individual supply flow path which communicates with the pressure chamber and through which the liquid is supplied to the pressure chamber; an individual discharge flow path which communicates with the pressure chamber and through which the liquid is discharged from the pressure chamber; a supply-side throttle portion provided in a middle of the individual supply flow path; and a discharge-side throttle portion provided in a middle of the individual discharge flow path, in which when a flow path resistance of the pressure chamber is referred to as Rcav, a flow path resistance of the supply-side throttle portion is referred to as Rin_res, a flow path resistance of the discharge-side throttle portion is referred to as Rout_res, a flow path resistance of a portion of the individual supply flow path other than the supply-side throttle portion is referred to as Rin_oth, and a flow path resistance of a portion of the individual discharge flow path other than the discharge-side throttle portion is referred to as Rout_oth, Rcav < Rin_res, Rcav < Rout_res, Rin_oth < Rin_res, and Rout_oth > Rout_res are satisfied.

According to another aspect of the present disclosure, there is provided a liquid ejecting apparatus including: the liquid ejecting head according to the aspect described above; and a control section that controls an ejection operation of the liquid ejecting head.

### BRIEF DESCRIPTION OF THE DRAWINGS

FIG. 1 is an exploded perspective view of a liquid ejecting head according to Embodiment 1.

FIG. 2 is a plan view of a main portion of a pressure chamber substrate and a communication plate according to Embodiment 1.

FIG. 3 is a cross-sectional view of a liquid ejecting head according to Embodiment 1.

FIG. 4 is a table illustrating a relationship between a flow path resistance and an evaluation of an action of Example and Comparative Example.

FIG. 5 is a view illustrating a schematic configuration of a liquid ejecting apparatus according to one embodiment.

### DESCRIPTION OF EMBODIMENTS

The present disclosure will be described in detail below based on embodiments. However, the following description illustrates one aspect of the present disclosure, and can be modified as desired within the scope of the present disclosure. In each drawing, the same reference numerals indicate the same members, and the description thereof will be omitted as appropriate. In addition, in each drawing, X, Y, and Z represent three spatial axes that are orthogonal to each other. In the present specification, directions along these axes will be referred to as an X direction, a Y direction, and a Z direction. In each drawing, a direction indicated by an arrow is a positive (+) direction, and a direction opposite to the arrow is a negative (-) direction. The Z direction indicates a vertical direction, the +Z direction indicates a vertically downward direction, and the -Z direction indicates a vertically upward direction. Furthermore, directions along the three spatial axes of which the positive direction and the negative direction are not limited will be referred to as an X-axis direction, a Y-axis direction, and a Z-axis direction.

### Embodiment 1

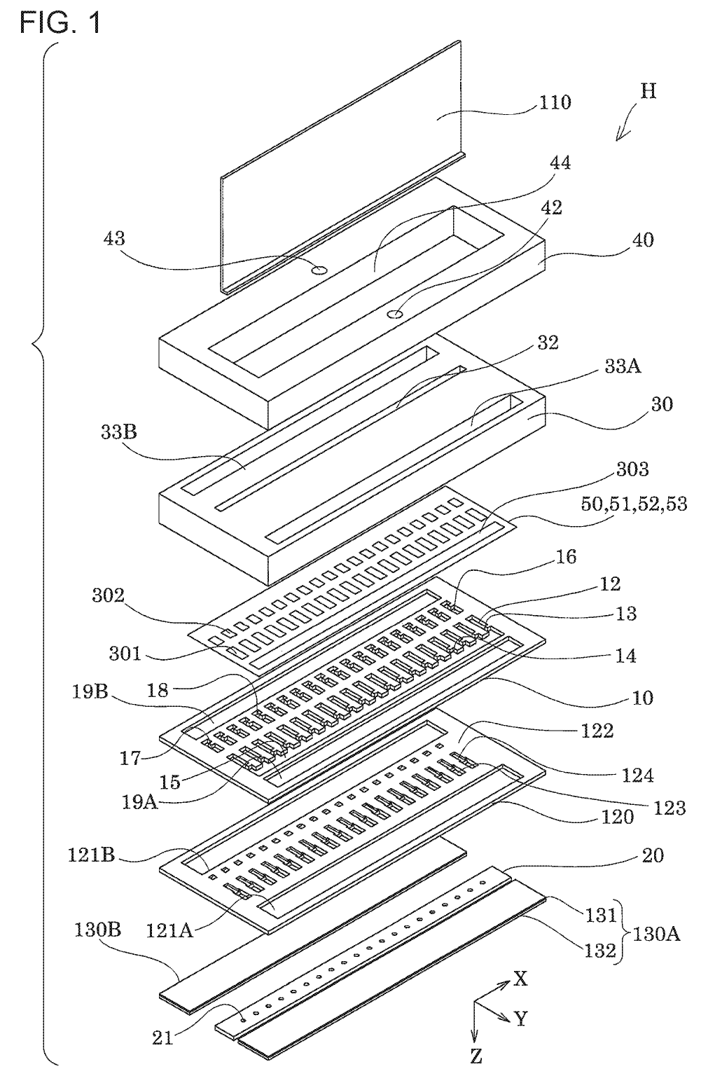

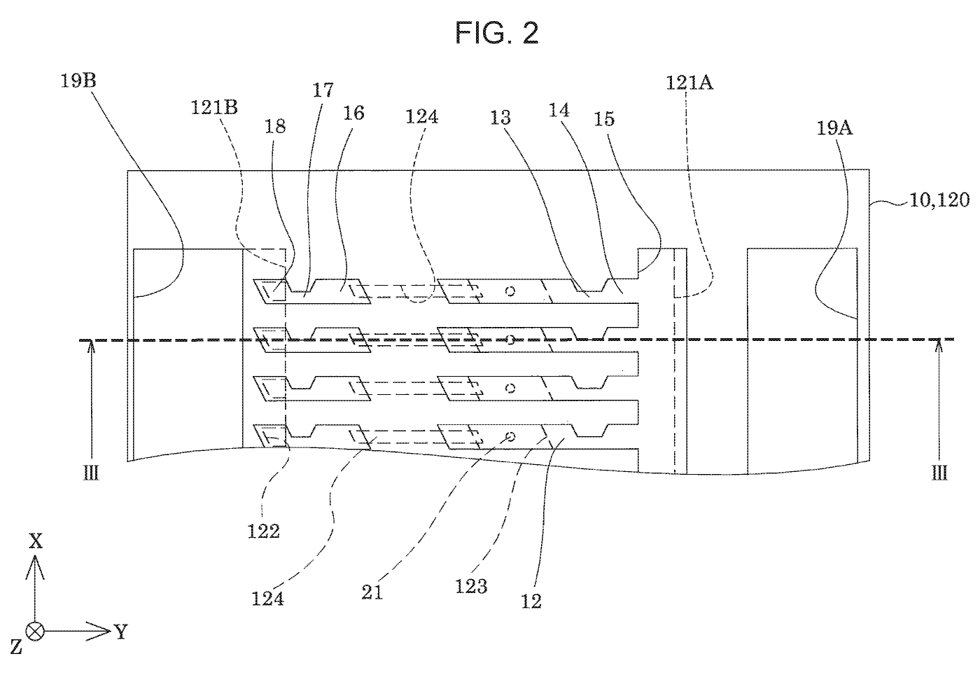

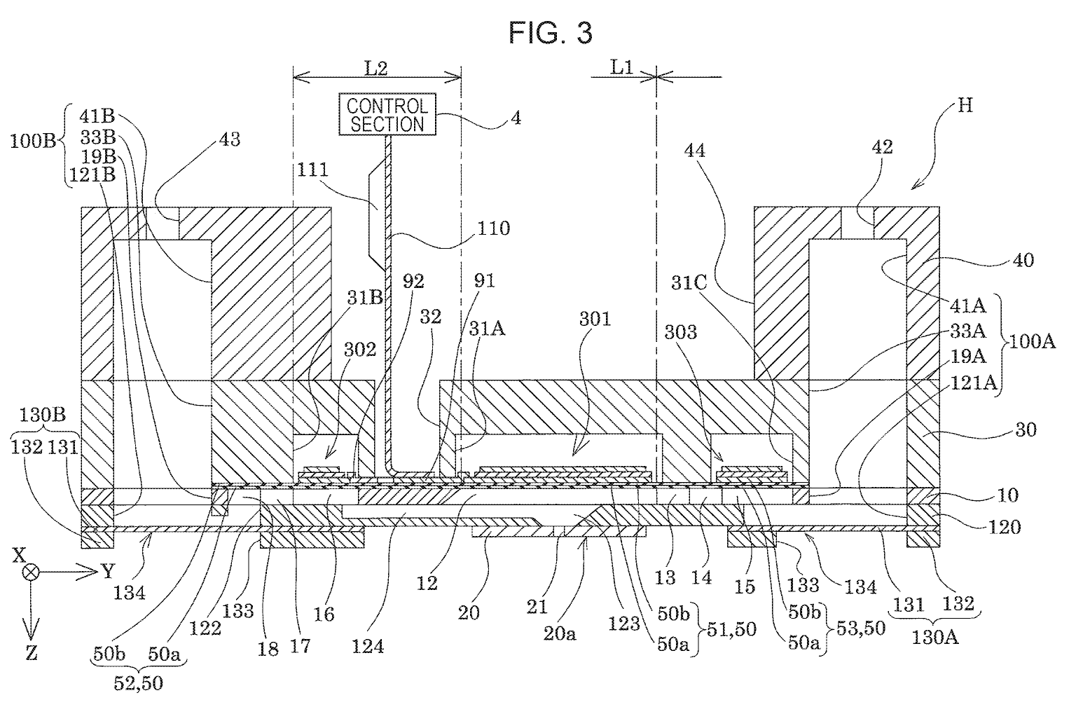

FIG. 1 is an exploded perspective view of a liquid ejecting head H according to Embodiment 1 of the present disclosure. FIG. 2 is a plan view of a pressure chamber substrate 10 and a communication plate 120 when viewed in the +Z direction. FIG. 3 is a cross-sectional view of the liquid ejecting head H including a line III-III in FIG. 2.

The liquid ejecting head H is configured as a head for ejecting inks in a printer. The ink is guided to the liquid ejecting head H, and a part thereof is ejected from a nozzle 21 to an outside, for example, to a printing medium. Since the ink is circulated, the ink which is not ejected from the nozzle 21 is discharged from the liquid ejecting head H. Therefore, in the present specification, the terms "supply-side" and "discharge-side" may be used. The term "supply-side" indicates upstream from a pressure chamber, which will be described below, with respect to a flow path of a liquid. In addition, a part related to upstream from the pressure chamber may be referred to as the "supply-side". The "discharge-side" indicates downstream of the pressure chamber 12 with respect to the flow path of the liquid. The term "discharge-side" does not include the nozzle 21 to be described below. In addition, a part related to downstream from the pressure chamber 12 may be referred to as the "discharge-side". In addition, the "discharge-side" may be referred to as a "collection-side". The liquid is not limited to the ink, and the liquid ejecting head H can be configured to eject other liquids.

As illustrated in the drawing, the liquid ejecting head H includes one nozzle substrate 20, one communication plate 120, one pressure chamber substrate 10, one protective substrate 30, and one case 40 in order in the -Z direction.

The pressure chamber substrate 10 is made of, for example, a silicon substrate, a glass substrate, an SOI substrate, or various ceramic substrates.

The pressure chamber substrate 10 is provided with a plurality of pressure chambers 12 extending in the Y-axis direction The plurality of pressure chambers 12 are disposed side by side on a straight line along the X-axis direction to be at the same position in the Y-axis direction (that is, to be at an overlapping position when viewed in the X-axis). The two pressure chambers 12 adjacent to each other in the X-axis direction are partitioned by a partition wall. Each of the plurality of pressure chambers 12 is formed by a through-hole penetrating the pressure chamber substrate 10 in the Z-axis direction from a surface facing the -Z direction to a surface facing the +Z direction, of the pressure chamber substrate 10. Here, the "through-hole" is a space defined by a side surface coupled to a surface of the pressure chamber substrate 10 facing the +Z direction from a surface of the pressure chamber substrate 10 facing the -Z direction. The side surface may be a surface inclined with respect to the Z-axis direction, that is, the through-hole may be defined by the inclined surface.

Further, the pressure chamber substrate 10 includes a supply-side throttle portion 13 that communicates with one end portion side of the pressure chamber 12 in the +Y direction, for each pressure chamber 12. The supply-side throttle portion 13 is defined in a through-hole penetrating the pressure chamber substrate 10 in the Z-axis direction, is formed with a width narrower than a width of the pressure chamber 12 in the X-axis direction, and maintains a flow path resistance of the ink flowing into the pressure chamber 12 from the upstream at a constant level. In the present embodiment, the supply-side throttle portion 13 is formed such that one side of the pressure chamber 12 in the X-axis direction is reduced, that is, one wall of the pressure chamber 12 in the X-axis direction is close to the other wall. Of course, the supply-side throttle portion 13 is not limited to this, and may be formed such that both sides of the pressure chamber 12 in the X-axis direction are reduced. In addition, the supply-side throttle portion 13 is not limited to the configuration in which the width in the X-axis direction is reduced, and may be configured such that a height in the Z-axis direction is reduced. The pressure chamber 12 refers to a portion up to a coupling port coupled to the supply-side throttle portion 13. In addition, a surface of the pressure chamber 12 and the supply-side throttle portion 13 in the -Z direction is defined by a first diaphragm 51.

Further, the pressure chamber substrate 10 has a supply-side communication chamber 14 that communicates with the pressure chamber 12 of the supply-side throttle portion 13 on the other end portion opposite to one end portion in the Y-axis direction, that is, an end portion in the +Y direction. That is, the pressure chamber 12 and the supply-side communication chamber 14 communicate with each other via the supply-side throttle portion 13. The supply-side communication chamber 14 is defined by a through-hole that penetrates the pressure chamber substrate 10 in the Z-axis direction. The supply-side communication chamber 14 is provided independently for each pressure chamber 12, that is, a plurality of supply-side communication chambers 14 are disposed side by side along the X-axis direction. That is, the plurality of supply-side communication chambers 14 are disposed on a straight line along the X-axis direction to be at the same position in the Y-axis direction (that is, to be at an overlapping position when viewed in the X-axis). The two supply-side communication chambers 14 adjacent to each other in the X-axis direction are partitioned by a partition wall. In the present embodiment, the supply-side communication chamber 14 are disposed to have the same width as the width of the pressure chamber 12 in the X-axis direction and the same pitch as a pitch of the pressure chamber 12 in the X-axis direction.

Further, the pressure chamber substrate 10 has an absorption chamber 15 that communicates with the other end portion opposite to the one end portion communicating with the supply-side throttle portion 13 of the supply-side communication chamber 14 in the Y-axis direction, that is, an end portion in the +Y direction. The absorption chamber 15 is defined by a through-hole penetrating the pressure chamber substrate 10 in the Z-axis direction. The pressure chamber 12 and the absorption chamber 15 communicate with each other via the supply-side throttle portion 13 and the supply-side communication chamber 14. The absorption chamber 15 is continuously provided over the plurality of supply-side communication chambers 14 along the X-axis direction. The absorption chamber 15 is defined by a third diaphragm 53 in the -Z direction. Such an absorption chamber 15 functions as a damper for absorbing vibration of the ink. The absorption chambers 15 may be provided independently for each of the pressure chambers 12, that is, a plurality of absorption chambers 15 may be disposed side by side along the X-axis direction. In addition, the absorption chamber 15 is not necessarily required, and the absorption chamber 15 may not be provided.

The pressure chamber substrate 10 has a detection chamber 16 on the -Y direction side, which is a side opposite to the supply-side throttle portion 13 of the pressure chamber 12 in the Y-axis direction, at a position separated from the pressure chamber 12 in the Y-axis direction. The detection chamber 16 is defined by a through-hole penetrating the pressure chamber substrate 10 in the Z-axis direction. The detection chamber 16 is provided independently for each pressure chamber 12, that is, a plurality of detection chambers 16 are disposed side by side along the X-axis direction. That is, the plurality of detection chambers 16 are disposed on a straight line along the X-axis direction to be at the same position in the Y-axis direction (that is, to be at an overlapping position when viewed in the X-axis). The two detection chambers 16 adjacent to each other in the X-axis direction are partitioned by a partition wall. In the present embodiment, the detection chambers 16 are disposed to have the same width as the width of the pressure chamber 12 in the X-axis direction and the same pitch as a pitch of the pressure chamber 12 in the X-axis direction. In addition, a surface of the detection chamber 16 in the -Z direction is defined by a second diaphragm 52. The detection chamber 16 is not always necessary, and the detection chamber 16 may not be provided.

Further, the pressure chamber substrate 10 includes the discharge-side throttle portion 17 communicating with an end portion of the detection chamber 16 in the -Y direction, for each detection chamber 16. The discharge-side throttle portion 17 is defined in a through-hole penetrating the pressure chamber substrate 10 in the Z-axis direction, is formed with a width narrower than a width of the detection chamber 16 in the X-axis direction, and maintains a flow path resistance of the ink flowing out from the detection chamber 16 to the downstream at a constant level. The discharge-side throttle portion 17 is formed such that one side of the pressure chamber 12 in the X-axis direction is reduced, in the same manner as the supply-side throttle portion 13. Of course, the discharge-side throttle portion 17 is not limited to this, and may be formed such that both sides of the pressure chamber 12 in the X-axis direction are reduced. In addition, the discharge-side throttle portion 17 is not limited to the configuration in which the width in the X-axis direction is reduced, and may be configured such that a height in the Z-axis direction is reduced. In the present embodiment, the supply-side throttle portion 13 and the discharge-side throttle portion 17 are provided only inside the pressure chamber substrate 10. By providing both the supply-side throttle portion 13 and the discharge-side throttle portion 17 on one pressure chamber substrate 10 in this manner, both can be formed by etching at the same time using the same mask, and thus, the both can be easily and accurately formed with a desired flow path resistance.

Further, the pressure chamber substrate 10 has a discharge-side communication chamber 18 that communicates with the other end portion opposite to one end portion that communicates with the detection chamber 16 of the discharge-side throttle portion 17 in the Y-axis direction, that is, an end portion in the -Y direction. The discharge-side communication chamber 18 is defined by a through-hole that penetrates the pressure chamber substrate 10 in the Z-axis direction. The discharge-side communication chamber 18 is provided independently for each of the discharge-side throttle portions 17, that is, a plurality of discharge-side communication chambers 18 are disposed side by side in the X-axis direction. That is, the plurality of discharge-side communication chambers 18 are disposed on a straight line along the X-axis direction to be at the same position in the Y-axis direction (that is, to be at an overlapping position when viewed in the X-axis). The two discharge-side communication chambers 18 adjacent to each other in the X-axis direction are partitioned by a partition wall. In the present embodiment, the discharge-side communication chamber 18 is disposed to have the same width as the width of the detection chamber 16 in the X-axis direction and the same pitch as a pitch of the detection chamber 16 in the X-axis direction. That is, in the present embodiment, the pressure chamber 12, the supply-side communication chamber 14, the detection chamber 16, and the discharge-side communication chamber 18 are provided with the same width in the X-axis direction and at the same pitch in the X-axis direction. The discharge-side communication chamber 18 and the detection chamber 16 communicate with each other via the discharge-side throttle portion 17. In the present embodiment, the discharge-side communication chamber 18 is provided independently for each detection chamber 16, but the present disclosure is not limited thereto, and the discharge-side communication chamber 18 may be continuously provided over a plurality of discharge-side throttle portions 17 along the X-axis direction.

In addition, the pressure chamber substrate 10 is formed with flow paths 19A and 19B that constitute a part of common liquid chambers 100A and 100B through which the plurality of pressure chambers 12 communicate in common, on both end portions in the Y-axis direction, that is, on both the outer sides of the absorption chamber 15 and the discharge-side communication chamber 18. In the present embodiment, the liquid ejecting head H is formed with the supply-side common liquid chamber 100A and the discharge-side common liquid chamber 100B, and the pressure chamber substrate 10 is provided with the flow path 19A constituting a part of the supply-side common liquid chamber 100A and the flow path 19B constituting a part of the discharge-side common liquid chamber 100B. The flow paths 19A and 19B are provided to penetrate the pressure chamber substrate 10 in the Z-axis direction.

The communication plate 120 and the nozzle substrate 20 are sequentially stacked on a surface of the pressure chamber substrate 10 facing the +Z direction.

The communication plate 120 has flow paths 121A and 121B constituting a part of each of the common liquid chambers 100A and 100B. The flow path 121A is a flow path that constitutes a part of the supply-side common liquid chamber 100A, and is provided to penetrate the communication plate 120 in the Z-axis direction, at a position overlapping the flow path 19A of the pressure chamber substrate 10 when viewed in the Z-axis direction. Further, the flow path 121A is extended in the -Y direction to a position overlapping the end portion of the absorption chamber 15 in the +Y direction when viewed in the Z-axis direction. Therefore, the flow path 121A communicates with the absorption chamber 15 of the pressure chamber substrate 10 in the Z-axis direction at an end portion in the -Y direction. The flow path 121B is a flow path that constitutes a part of the discharge-side common liquid chamber 100B, and is provided to penetrate the communication plate 120 in the Z-axis direction at a position overlapping the flow path 19B of the pressure chamber substrate 10 when viewed in the Z-axis direction. Further, the flow path 121B is extended in the +Y direction to a position overlapping an end portion of the discharge-side communication chamber 18 in the -Y direction when viewed in the Z-axis direction. The portion of the flow path 121B, which is extended in the +Y direction, has a recessed shape that opens on a surface facing the +Z direction without penetrating the communication plate 120 in the Z-axis direction. The communication plate 120 is provided with a discharge-side communication path 122 that communicates the discharge-side communication chamber 18 and the flow path 121B, and the ink in the discharge-side communication chamber 18 is discharged to the flow path 121B via the discharge-side communication path 122. In the present embodiment, the discharge-side communication path 122 is provided independently for each discharge-side communication chamber 18. Of course, the discharge-side communication path 122 may be continuously provided over the plurality of discharge-side communication chambers 18. In addition, a portion of the flow path 121B that is extended in the +Y direction and communicates with the discharge-side communication path 122, that is, a portion provided in a recessed shape that opens to a surface of the communication plate 120 facing the +Z direction may be provided independently for each discharge-side communication path 122, that is, a plurality of portions may be provided along the X-axis direction.

Further, the communication plate 120 includes a nozzle communication portion 123 that individually communicates each pressure chamber 12 and each nozzle 21, and a collection path 124 for collecting the ink in the nozzle communication portion 123 and the pressure chamber 12 to the outside of the liquid ejecting head H.

The nozzle communication portion 123 is defined by a through-hole penetrating the communication plate 120 in the Z-axis direction. A plurality of nozzle communication portions 123 are disposed side by side along the X-axis direction. That is, the plurality of nozzle communication portions 123 are disposed on a straight line along the X-axis direction to be at the same position in the Y-axis direction. The two nozzle communication portions 123 adjacent to each other in the X-axis direction are partitioned by a partition wall. In the present embodiment, the nozzle communication portion 123 is disposed to have substantially the same width as the width of the pressure chamber 12 in the X-axis direction and to have the same pitch as the pitch of the pressure chamber 12 in the X-axis direction. That is, the nozzle communication portion 123 is provided independently for each of the pressure chambers 12.

In such a nozzle communication portion 123, an end portion in the -Z direction directly communicates with the pressure chamber 12, and an end portion in the +Z direction directly communicates with the nozzle 21. That is, the nozzle 21 is directly coupled to the nozzle communication portion 123.

In addition, the nozzle communication portion 123 of the present embodiment is provided with a width in the Y-axis direction that is gradually decreased in the +Z direction. That is, side surfaces of the nozzle communication portion 123 on both sides in the Y-axis direction are inclined surfaces inclined in the Z-axis direction. Specifically, the side surface of the nozzle communication portion 123 in the -Y direction is formed of an inclined surface that is inclined toward the -Z direction as going in the -Y direction. In addition, the side surface of the nozzle communication portion 123 in the +Y direction is formed of an inclined surface that is inclined toward the -Z direction as going in the +Y direction. Therefore, when the ink flows from the pressure chamber 12 into the nozzle communication portion 123 along the Y-axis direction and the Z-axis direction, and when the ink flows out from the nozzle communication portion 123 into the pressure chamber 12, the ink can smoothly flow without being retained.

The collection path 124 is defined by a recess portion that is recessed in the +Z direction from the surface of the communication plate 120 facing the -Z direction and is coupled to the nozzle communication portion 123 at one end. The collection path 124 of the present embodiment opens to the surface of the communication plate 120 facing the -Z direction and does not open to a surface of the communication plate 120 facing the +Z direction, that is, is provided in a part of a thickness in the Z-axis direction without penetrating the communication plate 120 in the Z-axis direction. Therefore, the recess portion forming the collection path 124 does not open to the surface of the communication plate 120 facing the +Z direction. That is, the collection path 124 is not defined by the nozzle substrate 20 fixed to the surface of the communication plate 120 in the +Z direction. Such a collection path 124 is provided independently for each of the pressure chambers 12, that is, a plurality of collection paths 124 are provided independently in the X-axis direction. Further, the collection path 124 extends in the -Y direction from a coupling port with the nozzle communication portion 123. That is, when viewed in the +Z direction, the absorption chamber 15, the supply-side communication chamber 14, the supply-side throttle portion 13, the pressure chamber 12 and the nozzle communication portion 123, the collection path 124, the detection chamber 16, the discharge-side throttle portion 17, and the discharge-side communication chamber 18 are disposed side by side in the -Y direction.

One end of the collection path 124 in the +Y direction communicates with the nozzle communication portion 123, and the other end in the -Y direction is extended to a position overlapping an end portion of the detection chamber 16 in the +Y direction when viewed in the Z-axis direction. In the present embodiment in this manner, the collection path 124 is coupled to the nozzle communication portion 123 in the +Z direction with respect to the pressure chamber 12. Therefore, air bubbles pulled out from the nozzle 21 and entering the nozzle communication portion 123 and air bubbles entering the nozzle communication portion 123 from the supply-side throttle portion 13 can be discharged to the collection path 124 before the air bubbles rise in the pressure chamber 12 due to buoyancy. Therefore, an air-bubble discharge property can be improved by the collection path 124.

A width of the collection path 124 in the X-axis direction may be smaller than a width of the nozzle communication portion 123, or may be the same as the width of the nozzle communication portion 123. By setting the width of the collection path 124 in the X-axis direction to be smaller than the width of the nozzle communication portion 123, a flow path cross-sectional area of the collection path 124 can be reduced, and a flow velocity of the ink flowing in the collection path 124 can be increased. Therefore, air bubbles in the collection path 124 can be easily discharged from the collection path 124 to the outside. In addition, by setting the width of the collection path 124 in the X-axis direction to the same width as the nozzle communication portion 123, a step due to a width difference is not formed at a coupling portion of the nozzle communication portion 123 and the collection path 124, and occurrence of a problem in which the air bubbles are caught in the step and the air bubbles are not discharged can be suppressed.

The collection path 124 is coupled to the pressure chamber 12 in a region overlapping the pressure chamber 12 when viewed in the +Z direction. That is, since the collection path 124 is provided to open to the surface of the communication plate 120 facing the -Z direction, and the pressure chamber 12 is extended in the -Y direction from the nozzle communication portion 123, an opening of a surface of the communication plate 120 of the collection path 124, which faces the -Z direction, and a portion of the pressure chamber 12, which is extended in the -Y direction from the nozzle communication portion 123, communicate with each other in the Z-axis direction. In this manner, by directly coupling the collection path 124 to the pressure chamber 12, even when the air bubbles enter the pressure chamber 12 from the nozzle communication portion 123, the air bubbles in the pressure chamber 12 can be discharged to the collection path 124. Incidentally, when the collection path 124 is coupled to the nozzle communication portion 123 without being directly coupled to the pressure chamber 12, the air bubbles entering the pressure chamber 12 need to move to the collection path 124 via the nozzle communication portion 123, which is difficult.

The nozzle substrate 20 is a plate-shaped member joined to a surface of the pressure chamber substrate 10 opposite to the communication plate 120, that is, the surface facing the +Z direction. A plurality of nozzles 21 that communicate with each pressure chamber 12 via the nozzle communication portion 123 are formed in the nozzle substrate 20. In the present embodiment, the plurality of nozzles 21 are disposed side by side in a row along the X-axis direction. As such a nozzle substrate 20, a silicon substrate or an SOI substrate is preferably used. The material of the nozzle substrate 20 is not limited thereto, and a glass substrate, various ceramic substrates, a metal substrate such as a stainless steel substrate, or an organic material such as polyimide resin may be used. In the present embodiment, a surface of the nozzle substrate 20 facing the +Z direction in which the nozzle 21 opens is referred to as a nozzle surface 20a.

In such a flow path configuration, the ink in the common liquid chamber 100A is supplied to the nozzle 21 via the absorption chamber 15, the supply-side communication chamber 14, the supply-side throttle portion 13, the pressure chamber 12, and the nozzle communication portion 123. The ink that is not ejected from the nozzle 21 in the pressure chamber 12 and the nozzle communication portion 123 is collected in the common liquid chamber 100B via the collection path 124, the detection chamber 16, the discharge-side throttle portion 17, the discharge-side communication chamber 18, and the discharge-side communication path 122. Among these, a flow path that is located upstream of the pressure chamber 12, directly communicates with the pressure chamber 12, and is individually provided for each pressure chamber 12 is referred to as an "individual supply flow path". That is, in the present embodiment, the "individual supply flow path" that communicates with the pressure chamber 12 and supplies the ink to the pressure chamber 12 is the supply-side throttle portion 13 and the supply-side communication chamber 14, and a "portion of the individual supply flow path excluding the supply-side throttle portion 13" is the supply-side communication chamber 14. Further, a flow path that is located downstream of the pressure chamber 12, directly communicates with the pressure chamber 12, and is individually provided for each pressure chamber 12 is referred to as an "individual discharge flow path". That is, in the present embodiment, the "individual discharge flow path" that communicates with the pressure chamber 12 and discharges the ink from the pressure chamber 12 is the collection path 124, the detection chamber 16, the discharge-side throttle portion 17, the discharge-side communication chamber 18, and the discharge-side communication path 122, and a "portion of the individual discharge flow path other than the discharge-side throttle portion 17" is the collection path 124, the detection chamber 16, the discharge-side communication chamber 18, and the discharge-side communication path 122. In addition, it is preferable that the individual supply flow path and the individual discharge flow path are provided only inside the pressure chamber substrate 10 and the communication plate 120, respectively, as described below, but the present disclosure is not limited thereto. When the discharge-side communication chamber 18 is continuously provided over a plurality of discharge-side throttle portions 17, the discharge-side communication chamber 18 is not included in the individual discharge flow path. Further, when the discharge-side communication path 122 is continuously provided over the plurality of discharge-side communication chambers 18, the discharge-side communication path 122 is not included in the individual discharge flow path. In the present embodiment, the individual supply flow path, the individual discharge flow path, the pressure chamber 12, the nozzle communication portion 123, and the nozzle 21 are collectively referred to as an "individual flow path". A plurality of individual flow paths are provided side by side in the X-axis direction to extend in the Y-axis direction. The "throttle portion" in the present disclosure refers to a portion in which a cross section perpendicular to a flow path extending direction is the smallest in each individual flow path. The pressure chamber 12 is provided between the supply-side throttle portion 13 and the discharge-side throttle portion 17 in the Y-axis direction. In the present embodiment, a distance L1 between the pressure chamber 12 and the supply-side throttle portion 13 in the Y-axis direction is shorter than a distance L2 between the pressure chamber 12 and the discharge-side throttle portion 17 in the Y-axis direction. In the present embodiment, the distance L1 between the pressure chamber 12 and the supply-side throttle portion 13 and the distance L2 between the pressure chamber 12 and the discharge-side throttle portion 17 in the Y-axis direction are the shortest distances between the end portions of the pressure chamber 12, the supply-side throttle portion 13, and the discharge-side throttle portion 17 in the Y-axis direction, on the surface in the -Z direction defined by the diaphragm 50. Of course, the distances L1 and L2 are not limited to this, and may be a distance between centers. Incidentally, since the pressure chamber 12 and the supply-side throttle portion 13 directly communicate with each other, the distance L1 is 0 (zero). By setting the distance between the pressure chamber 12 and the discharge-side throttle portion 17 to be relatively long in this manner, ejection characteristics of the ink droplets ejected from the nozzle 21 can be stabilized, as compared with a case where the discharge-side throttle portion 17 having a high local flow path resistance immediately after the pressure chamber 12 is provided. Incidentally, when the discharge-side throttle portion 17 is provided immediately after the pressure chamber 12, the ink in the pressure chamber 12 is likely to advance toward the nozzle 21, and the ejection characteristics of the ink droplets ejected from the nozzle 21 are likely to be disturbed.

Further, a flow path in which a plurality of individual flow paths communicate with each other in common is referred to as a "common flow path", a common flow path on the supply-side is referred to as a "common supply flow path", and a common flow path on the discharge-side is referred to as a "common discharge flow path". In the present embodiment, the "common supply flow path" includes the common liquid chamber 100A and the absorption chamber 15, and the "common discharge flow path" includes the common liquid chamber 100B. In this manner, the detection chamber 16 and the pressure chamber 12 form a part of the individual flow path instead of the common flow path, so that residual vibration in each pressure chamber 12 can be individually detected in the detection chamber 16, and an ejection failure of each nozzle 21 can be individually detected. Further, by constituting a part of the individual discharge flow path with the detection chamber 16, a flow path length of the individual supply flow path can be shortened, as compared with a case where the detection chamber 16 is provided to constitute a part of the individual supply flow path. Therefore, by shortening the flow path length of the individual supply flow path, a pressure loss can be reduced and occurrence of a problem in which the ink is not supplied to the pressure chamber 12 can be suppressed.

Here, in the circulation type liquid ejecting head H of the present embodiment that communicates the nozzle 21 with the pressure chamber 12 and supplies and ejects the ink to and from the pressure chamber 12, since the nozzle 21 communicates directly below the pressure chamber 12, the air bubbles or the thickened ink accumulated in the pressure chamber 12 can be preferably ejected via the nozzle 21 while the ejection efficiency is improved, and recovery performance of the nozzle 21 can be improved. In such a liquid ejecting head H, it is necessary to provide the supply-side throttle portion 13 and the discharge-side throttle portion 17, each of which has a large flow path resistance, on the supply-side and the discharge-side of the pressure chamber 12. This is because three of the nozzle 21, the individual supply flow path, and the individual discharge flow path communicate with the pressure chamber 12, and when the supply-side throttle portion 13 and the discharge-side throttle portion 17 are not provided, even when the ink in the pressure chamber 12 is pressurized by the first piezoelectric element 301 which is an energy generation element, the pressure escapes to the individual supply flow path or the individual discharge flow path. As a result, the pressure toward the nozzle 21 becomes relatively small, and the ejection characteristics such as the weight and the flight speed of the ink droplets ejected from the nozzle 21 deteriorate. Therefore, the liquid ejecting head H of the present embodiment is provided with the supply-side throttle portion 13 and the discharge-side throttle portion 17, so that the pressure toward the nozzle 21 in the pressure chamber 12 when the first piezoelectric element 301 is driven is increased, and a decrease in the ejection characteristics such as the weight and the flight speed of the ink droplets ejected from the nozzle 21 can be suppressed. A flow path resistance of each portion of the individual supply flow path and the individual discharge flow path needs to be set in view of the following (Condition A) to (Condition C).

### Condition A

Here, it is found that when flow path resistances of the supply-side throttle portion 13 and the discharge-side throttle portion 17 is made to be significantly different, ejection characteristics of ink droplets ejected from the nozzle 21, particularly, an ejection direction is affected. For example, when the flow path resistance of the supply-side throttle portion 13 is significantly larger than the flow path resistance of the discharge-side throttle portion 17, a pressure applied to the ink in the pressure chamber 12 when the first piezoelectric element 301, which is an energy generation element, is driven is substantially not applied to the individual supply flow path. Although the discharge-side throttle portion 17 is provided, when the flow path resistance of the supply-side throttle portion 13 is significantly large, the pressure is applied not only to the nozzle 21 but also to the individual discharge flow path. As a result, inside the pressure chamber 12, an unbalanced pressure balance is obtained in which the supply-side is high pressure and the discharge-side is low pressure, and the ink droplets ejected from the nozzle 21 are shifted to the discharge-side, and the ejection direction is inclined. When the ejection direction is inclined, landing position shifting to a recording medium occurs, and a printing quality deteriorates. In order to suppress the inclination of the ink droplet in the ejection direction, it is preferable that the flow path resistance of the supply-side throttle portion 13 and the flow path resistance of the discharge-side throttle portion 17 are not significantly different from each other.

### Condition B

Regarding a portion of the individual supply flow path other than the supply-side throttle portion 13 (hereinafter referred to as a "portion other than the supply-side"), it is preferable that the flow path resistance is relatively small. Since the smaller the overall flow path resistance of the circulation system, the higher the circulation flow rate, the circulation function is in accordance with the original purpose of discharging a foreign matter, air bubbles, and the like in the pressure chamber 12 or the nozzle 21, discharging the thickened ink, and keeping the ink in the pressure chamber 12 or the nozzle 21 in a fresh state. Therefore, the flow path resistance of the individual supply flow path, which is a part of a serial circuit structure, is also naturally desired to be reduced. Meanwhile, the supply-side throttle portion 13 is required to be provided, and thus it is preferable to reduce the flow path resistance of the portion other than the supply-side as much as possible. Therefore, the portion other than the supply-side needs to have a smaller flow path resistance than the supply-side throttle portion 13.

### Condition C

It is preferable that the flow path resistance of the individual discharge flow path is small in consideration of the circulation flow rate, but a different problem occurs when the flow path resistance is reduced, unlike the individual supply flow path. In the liquid ejecting head H that circulates the ink, the individual supply flow path and the pressure chamber 12 are coupled in series, but the pressure chamber 12 branches into the nozzle 21 and the individual discharge flow path. Here, when the flow path resistance of the individual discharge flow path is excessively smaller than that of the nozzle 21, the liquid only flows toward the individual discharge flow path, and a phenomenon occurs in which the supply of the ink to the nozzle 21, so-called refill, is delayed. This phenomenon is particularly likely to occur when ink droplets are continuously ejected from the nozzle 21 such that a drive frequency is 60 kHz or higher. Therefore, the individual discharge flow path is preferably set to have a certain degree of large flow path resistance. In addition, it is also conceivable to increase the flow path resistance of the discharge-side throttle portion 17 of the individual discharge flow path. Meanwhile, as described in Condition A, the discharge-side throttle portion 17 cannot largely change the flow path resistance from the supply-side throttle portion 13. Therefore, by increasing the flow path resistance of a portion (hereinafter referred to as a "portion other than the discharge-side") of the individual discharge-side flow path other than the discharge-side throttle portion 17, the flow path resistance of the entire individual discharge flow path is increased. From these points, the portion other than the discharge-side has a larger flow path resistance than the discharge-side throttle portion 17.

In order to satisfy Conditions A to C, the present disclosure defines the flow path resistance of the individual flow path as at least the following.

When the flow path resistance of the pressure chamber 12 is Rcav, the flow path resistance of the supply-side throttle portion 13 is Rin_res, and the flow path resistance of the discharge-side throttle portion 17 is Rout_res, the flow path resistance Rin_res of the supply-side throttle portion 13 is larger than the flow path resistance Rcav of the pressure chamber 12, and the flow path resistance Rout_res of the discharge-side throttle portion 17 is larger than the flow path resistance Rcav of the pressure chamber 12. That is, Rcav < Rin_res and Rcav < Rout_res are satisfied. Therefore, when the ink in the pressure chamber 12 is pressurized by the first piezoelectric element 301, the pressure from escaping to the individual supply flow path or the individual discharge flow path can be suppressed. Therefore, an increase in the pressure in the pressure chamber 12 directed to the nozzle 21 and a decrease in the ejection characteristics such as the weight and the flight speed of the ink droplets ejected from the nozzle 21 can be suppressed.

When a portion of the individual supply flow path other than the supply-side throttle portion 13, that is, the flow path resistance of the supply-side communication chamber 14 is defined as Rin_oth, and a portion of the individual discharge flow path other than the discharge-side throttle portion 17, that is, the flow path resistance of the collection path 124, the detection chamber 16, the discharge-side communication chamber 18, and the discharge-side communication path 122 is defined as Rout_oth, the flow path resistance Rin_oth is smaller than the flow path resistance Rin_res, and the flow path resistance Rout_oth is larger than the flow path resistance Rout_res. That is, Rin_oth < Rin_res and Rout_oth > Rout_res are satisfied. This is Condition 1 to be described below. In the present embodiment, by holding Rin_oth < Rin_res, the flow path resistance of the entire individual supply flow path is reduced, the flow rate of the ink circulating in the pressure chamber 12 is increased, and the air bubbles or the thickened ink in the pressure chamber 12 can be preferably discharged by the circulation, and the recovery performance can be improved. That is, Condition B can be satisfied. In addition, by holding Rout_oth > Rout_res, the delay in refilling of the ink to the nozzle 21 side can be suppressed, without excessively reducing the overall flow path resistance of the individual discharge flow path. Even when the drive frequency is 60 kHz or higher, the delay in refilling by performing continuous high-frequency ejection can be suppressed. That is, Condition C can be satisfied.

### Examples 1 to 23, and Comparative Examples 1 to 6

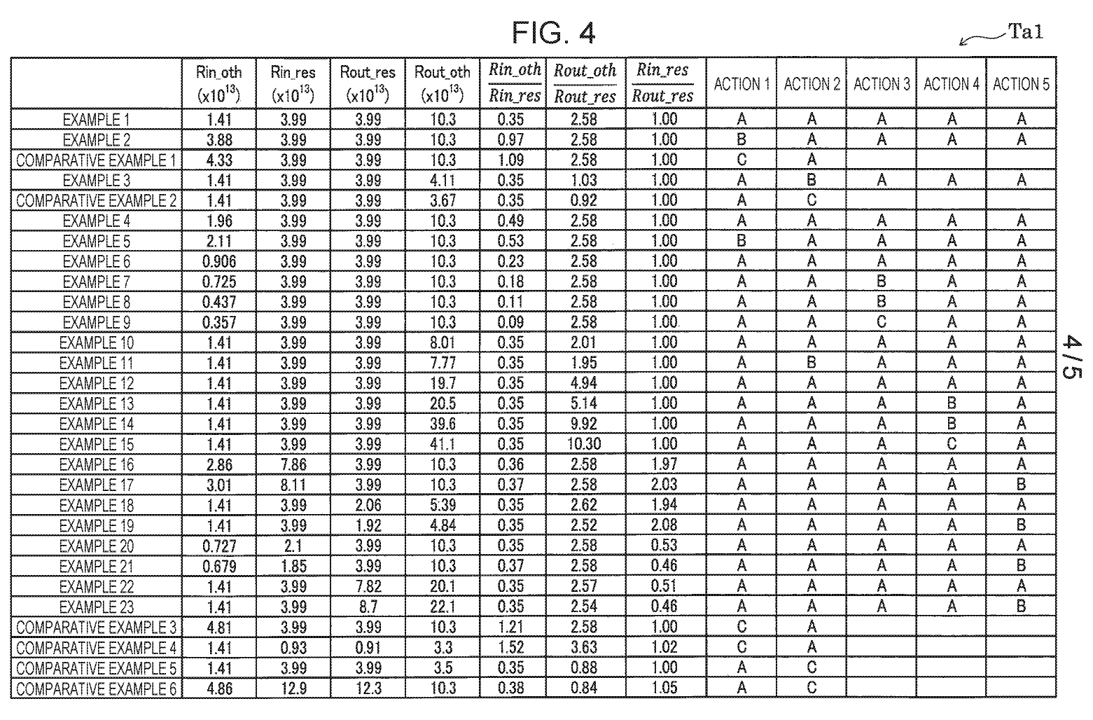

Here, a table Ta1 in FIG. 4 illustrates values of the flow path resistance Rin_res of the supply-side throttle portion 13, the flow path resistance Rout_res of the discharge-side throttle portion 17, the flow path resistance Rin_oth of the portion other than the supply-side throttle portion 13 in the individual supply flow path, and the flow path resistance Rout_oth of the portion other than the discharge-side throttle portion 17 in the individual discharge flow path in Examples 1 to 23 and Comparative Examples 1 to 6, a ratio of the flow path resistance Rin_oth to the flow path resistance Rin_res, a ratio of the flow path resistance Rout_oth to the flow path resistance Rout_res, and a ratio of the flow path resistance Rin_res to the flow path resistance Rout_res, and Evaluation A to C of related Actions 1 to 5.

Although not illustrated in the table Ta1, in Examples 1 to 23 and Comparative Examples 1 to 6, the flow path resistance Rcav of the pressure chamber 12 is smaller than the flow path resistance Rin_res of the supply-side throttle portion 13 and the flow path resistance Rout_res of the discharge-side throttle portion 17. That is, Rcav < Rin_res and Rcav < Rout_res are satisfied.

### Evaluation

Examples 1 to 23 and Comparative Examples 1 to 6 illustrated in the table Ta1 are evaluated in three stages of Evaluations A to C from five viewpoints of Actions 1 to 5. Details of each of Evaluations are as follows.

### Action 1

Action 1 corresponds to Condition B described above. Regarding Action 1, each of Evaluation A, B, and C is evaluated as follows.

Evaluation A: There is no insufficient circulation flow rate due to an increase in the flow path resistance of the supply-side flow path.

Evaluation B: Although the circulation flow rate is slightly insufficient due to an increase in the flow path resistance of the supply-side flow path, the circulation flow rate is within an allowable range.

Evaluation C: The circulation flow rate shortage due to the increase in the flow path resistance of the supply-side flow path exceeded the allowable range.

### Action 2

Action 2 corresponds to Condition C described above. Regarding Action 2, each of Evaluations A, B, and C is evaluated as follows.

Evaluation A: Even when driven at a high drive frequency of about 60 kHz, there is no ink skipping (also referred to as slipping) on a recording medium due to a refill shortage.

Evaluation B: Although slight ink skipping is observed during high-frequency driving, no ink skipping is observed during low-frequency driving of about 30 kHz.

Evaluation C: Ink skipping occurs even in the low-frequency drive, and particularly in the high-frequency drive, the ink skipping is remarkable.

### Action 3

The flow path resistance Rin_oth of the portion other than the supply-side is extremely smaller than the flow path resistance Rin_res of the supply-side throttle portion 13, and thus a load of the liquid pressure is concentrated locally on the supply-side throttle portion 13 having a very short flow path length, and there is a possibility that the supply-side throttle portion 13 is damaged. Action 3 suppresses the damage of the supply-side throttle portion 13. Regarding Action 3, each of Evaluation A, B, and C is evaluated as follows.

Evaluation A: No damage due to a hydraulic load is observed in the supply-side throttle portion.

Evaluation B: Damage due to the hydraulic load slightly occurs in the supply-side throttle portion by continuous use for about 1000 hours.

Evaluation C: Damage due to the hydraulic load occurs slightly in the supply-side throttle portion by continuing to use for about 700 hours.

### Action 4

In the individual flow path, the portion other than the discharge-side has the largest flow path resistance, and the flow path resistance has a large influence on the entire flow path resistance of the individual flow path. When the flow path resistance of such a portion other than the discharge-side is excessively increased, the flow path resistance of the entire individual flow path becomes excessive, and the circulation flow rate may be insufficient. Action 4 is to eliminate the insufficient circulation flow rate due to the flow path resistance of the discharge-side flow path. Regarding Action 4, each of Evaluations A, B, and C is evaluated as follows.

Evaluation A: There is no insufficient circulation flow rate due to an increase in the flow path resistance of the discharge-side flow path.

Evaluation B: Although the circulation flow rate is slightly insufficient due to the increase in the flow path resistance of the discharge-side flow path, the influence is not so large.

Evaluation C: A large amount of insufficient circulation flow rate due to an increase in the flow path resistance of the discharge-side flow path occurs.

### Action 5

Action 5 corresponds to Condition A described above. Regarding Action 5, Evaluations A and B are evaluated as follows.

Evaluation A: No deviation of a dot formed at the recording medium from the ideal position is observed. Evaluation B: The formed dot is slightly shifted from the ideal landing position.

### Examples 1 to 23

### Condition 1

In Examples 1 to 23, as illustrated in the table Ta1, both Action 1 and Action 2 have A or B. It is considered that Examples 1 to 23 satisfy Rin_oth < Rin_res and Rout_oth > Rout_res. On the other hand, in Comparative Examples 1, 3, and 4, Action 1 has C. It is considered that Comparative Examples 1, 3, and 4 do not satisfy Rin_oth < Rin_res. In addition, in Comparative Examples 2, 5, and 6, Action 2 has C. It is considered that Comparative Examples 2, 5, and 6 do not satisfy Rout_oth > Rout_res.

Further, more preferable Conditions 2 to 8 of the present disclosure are illustrated below.

### Condition 2

Among Examples that satisfy Condition 1, Examples 1, 3, 4, and 6 to 23 have Action 1 as A. It is considered that Examples 1, 3, 4, and 6 to 23 satisfy Rin_oth < 0.5 × Rin_res. On the other hand, for example, in Example 5, Action 1 has B. It is considered that Example 5 does not satisfy Rin_oth < 0.5 × Rin_res.

### Condition 3

Among Examples that satisfy Condition 1, in Examples 1 to 8 and 10 to 23, Action 3 has A or B. It is considered that Examples 1 to 8 and 10 to 23 satisfy Rin_oth > 0.1 × Rin_res. On the other hand, for example, in Example 9, Action 3 has C. It is considered that Example 9 does not satisfy Rin_oth > 0.1 × Rin_res.

### Condition 4

Among Examples that satisfy Condition 3, Examples 1 to 6 and 10 to 23 had Action 3 as A. It is considered that Examples 1 to 6 and 10 to 23 satisfy Rin_oth > 0.2 × Rin_res. On the other hand, for example, in Examples 7 and 8, Action 3 has B. It is considered that Examples 7 and 8 do not satisfy Rin_oth > 0.2 × Rin_res.

### Condition 5

Among Examples that satisfy Condition 1, Examples 1, 2, 4 to 10, and 12 to 23 had Action 2 as A. It is considered that Examples 1, 2, and 4 to 10, and 12 to 23 satisfy Rout_oth > 2.0 × Rout_res. On the other hand, for example, in Example 11, Action 2 has B. It is considered that Example 11 does not satisfy Rout_oth > 2.0 × Rout_res.

### Condition 6

Among Examples that satisfy Condition 1, in Examples 1 to 14 and 16 to 23, and Action 4 has A or B. It is considered that Examples 1 to 14 and 16 to 23 satisfy Rout_oth < 10.0 × Rout_res. On the other hand, for example, in Example 15, Action 4 has C. It is considered that Example 15 does not satisfy Rout_oth < 10.0 × Rout_res.

### Condition 7

Among Examples that satisfy Condition 6, Examples 1-12 and 16-23 had Action 4 as A. It is considered that Examples 1-12 and 16-23 satisfy Rout_oth < 5.0 × Rout_res. On the other hand, for example, in Examples 13 and 14, Action 4 has B. It is considered that Examples 13 and 14 do not satisfy Rout_oth < 5.0 × Rout_res.

### Condition 8

Among Examples that satisfy Condition 1, Examples 1-16, 18, 20, and 22 had Action 5 as A. It is considered that Examples 1 to 16, 18, 20, and 22 satisfy 0.5 < Rin_res / Rout_res < 2.0. On the other hand, for example, in Examples 17, 19, 21, and 23, Action 5 has B. It is considered that Examples 17, 19, 21, and 23 do not satisfy 0.5 < Rin_res / Rout_res < 2.0. More preferably, Rin_res = Rout_res.

On the other hand, as illustrated in FIGS. 1 to 3, the first piezoelectric element 301, the second piezoelectric element 302, and the third piezoelectric element 303 are stacked on the surface of the pressure chamber substrate 10 facing the -Z direction via the first diaphragm 51, the second diaphragm 52, and the third diaphragm 53 as described above.

In the present embodiment, the first diaphragm 51, the second diaphragm 52, and the third diaphragm 53 have the same stack structure of the same material having the same thickness. Therefore, hereinafter, the first diaphragm 51, the second diaphragm 52, and the third diaphragm 53 are referred to as the diaphragm 50 when not distinguished. Of course, the first diaphragm 51, the second diaphragm 52, and the third diaphragm 53 may have different stack structures such as a film thickness and a material.

The first diaphragm 51 has, for example, an elastic film 50a made of silicon oxide provided on the pressure chamber substrate 10 side, and an insulator film 50b made of zirconium oxide disposed on a surface of the elastic film 50a facing the -Z direction. In the present embodiment, the second diaphragm 52 and the third diaphragm 53 are continuously provided with the first diaphragm 51. That is, the second diaphragm 52 and the third diaphragm 53 include the elastic film 50a and the insulator film 50b. The diaphragm 50 may be configured with only the elastic film 50a, may be configured with only the insulator film 50b, or may be configured with other films in addition to the elastic film 50a and the insulator film 50b. The diaphragm 50 provided on the surface of the pressure chamber substrate 10 facing the -Z direction is referred to as the first diaphragm 51, a portion of the opening of the surface of the pressure chamber substrate 10 facing the -Z direction that covers the pressure chamber 12, a second diaphragm 52, a portion of the opening of the surface of the pressure chamber substrate 10 facing the -Z direction that covers the detection chamber 16, and a third diaphragm 53, a portion of the opening of the surface of the pressure chamber substrate 10 facing the -Z direction that covers the absorption chamber 15. A recess portion serving as the pressure chamber 12, the supply-side throttle portion 13, the absorption chamber 15, the detection chamber 16, the discharge-side throttle portion 17, and the discharge-side communication chamber 18 may be formed by etching the surface of the pressure chamber substrate 10 facing the +Z direction, in the -Z direction. In this case, since a bottom surface of the recess portion serves as the elastic film 50a, the pressure chamber substrate 10 and the elastic film 50a, which is a part of the diaphragm 50, are integrally formed. Further, the entire diaphragm 50 and the pressure chamber substrate 10 may be integrally formed.

All of the first piezoelectric element 301, the second piezoelectric element 302, and the third piezoelectric element 303 have an electrode on an upper surface facing the -Z direction and a lower surface facing the +Z direction of a piezoelectric body configured with a piezoelectric material made of a composite oxide having a perovskite structure represented by the general formula ABO₃. When a voltage is applied between the upper and lower electrodes, the piezoelectric body interposed between the two electrodes is deformed by an electrostriction effect, and on the other hand, when force that deforms the piezoelectric body from the outside is applied, a voltage is generated between the electrodes by a piezoelectric effect. In the present embodiment, the first piezoelectric element 301, the second piezoelectric element 302, and the third piezoelectric element 303 have the same general configuration, but the first piezoelectric element 301 is used as a piezoelectric element that generates vibration by applying a voltage between electrodes to the first diaphragm 51, and the second piezoelectric element 302 is used as a piezoelectric element that generates pressure by applying a vibration applied from the outside to the second diaphragm 52, and thereby detects vibration. The configuration of the third piezoelectric element 303 is the same as the configuration of the other piezoelectric elements, but the upper and lower electrodes are not electrically coupled to each other, and the third piezoelectric element 303 is used as a mass for absorbing a pressure change of the ink in the absorption chamber 15. In addition, in the present embodiment, the first piezoelectric element 301, the second piezoelectric element 302, and the third piezoelectric element 303 are formed at the same time with the same material. Therefore, manufacturing costs can be reduced. Of course, the first piezoelectric element 301, the second piezoelectric element 302, and the third piezoelectric element 303 may be formed by different manufacturing processes using materials which are different from each other.

In the present embodiment, the first piezoelectric element 301 is provided for each pressure chamber 12. That is, a plurality of first piezoelectric elements 301 are provided in parallel on the first diaphragm 51 in the X-axis direction. Such a first piezoelectric element 301 is also referred to as a piezoelectric actuator. The first piezoelectric element 301 is deformed to bend and deform the first diaphragm 51, thereby causing a pressure change in the ink in the pressure chamber 12. That is, the first piezoelectric element 301 is an energy generation element that causes a pressure change in the ink in the pressure chamber 12.

In addition, a first lead electrode, which is a lead wiring, is drawn from each electrode of the first piezoelectric element 301. The flexible substrate 110, which is a flexible wiring substrate, is coupled to the end portion of a first lead electrode 91 opposite to the end portion coupled to the first piezoelectric element 301. The flexible substrate 110 is electrically coupled to a control section 4, and exchanges a signal for driving the first piezoelectric element 301, a detection signal corresponding to the residual vibration generated in the second piezoelectric element 302, and the like with the control section 4 via a control circuit 111. That is, the control circuit 111 includes a plurality of switching elements for selecting whether or not to supply a drive signal for driving each of the first piezoelectric elements 301 to each first piezoelectric element 301. That is, the flexible substrate 110 in the present embodiment is a chip on film (COF). The flexible substrate 110 may not be provided with the control circuit 111. That is, the flexible substrate 110 may be a flexible flat cable (FFC), a flexible printed circuit (FPC), or the like.

The third piezoelectric element 303 is disposed at a position overlapping the absorption chamber 15 when viewed in the Z-axis direction. The third piezoelectric element 303 has the same stack configuration as the first piezoelectric element 301. The third piezoelectric element 303 is not always necessary, and the third piezoelectric element 303 may not be provided.

The second piezoelectric element 302 is disposed at a position overlapping the detection chamber 16 when viewed in the Z-axis direction. The second piezoelectric element 302 has the same stack configuration as the first piezoelectric element 301. In the present embodiment, the second piezoelectric element 302 is formed for each detection chamber 16. That is, the plurality of second piezoelectric elements 302 are provided in parallel on the second diaphragm 52 of the pressure chamber substrate 10 in the X-axis direction. The second piezoelectric element 302 is a detection element that detects a pressure fluctuation in each detection chamber 16. Further, a second lead electrode 92, which is a lead wiring, is drawn out from each electrode of the second piezoelectric element 302. Each electrode of the second piezoelectric element 302 is coupled to the flexible substrate 110 via the second lead electrode 92. The second piezoelectric element 302 is not always necessary, and the second piezoelectric element 302 may not be provided.

Here, when the first piezoelectric element 301 causes a pressure fluctuation in the ink in the pressure chamber 12 and ejects an ink droplet from the nozzle 21, the pressure fluctuation in the pressure chamber 12 remains for a predetermined period even after the ink droplet is ejected. This is called residual vibration. Since the pressure fluctuation of the ink in the pressure chamber 12 is also propagated to the ink in the detection chamber 16 via the collection path 124, the second piezoelectric element 302 detects the residual vibration of the detection chamber 16. That is, the second piezoelectric element 302 detects the residual vibration as a voltage signal by a generated electromotive force when the residual vibration of the ink in the detection chamber 16 varies. The control circuit 111 extracts information on a state of the residual vibration, for example, a period, an amplitude, and the like of the residual vibration from the voltage signal generated in the second piezoelectric element 302, and outputs the information to the control section 4. The control section 4 detects an ejection failure of the ink droplet from the information such as the period and the amplitude of the residual vibration.

The protective substrate 30 having substantially the same size as the pressure chamber substrate 10 is joined to the surface of the pressure chamber substrate 10 facing the -Z direction. The protective substrate 30 has accommodation sections 31A to 31C which are spaces for protecting the first piezoelectric element 301, the second piezoelectric element 302, and the third piezoelectric element 303, respectively. Further, the protective substrate 30 has an opening portion 32 penetrating in the Z-axis direction between the two accommodation sections 31A and accommodation section 31B disposed side by side in the Y-axis direction. Each end portion of the first lead electrode 91 drawn from each electrode of the first piezoelectric element 301 and the second lead electrode 92 drawn from each electrode of the second piezoelectric element 302 is electrically coupled to the flexible substrate 110 in the opening portion 32.

The protective substrate 30 has a flow path 33A constituting a part of the supply-side common liquid chamber 100A and a flow path 33B constituting a part of the discharge-side common liquid chamber 100B. The flow paths 33A and 33B are provided to penetrate the protective substrate 30 in the Z-axis direction. The flow path 33A is located in the +Y direction of the accommodation section 31C, and the flow path 33B is located in the -Y direction of the accommodation section 31B.

The case 40 is located on the -Z direction side of the protective substrate 30. The case 40 has a flow path 41A constituting a part of the supply-side common liquid chamber 100A and a flow path 41B constituting a part of the discharge-side common liquid chamber 100B. The flow path 41A is disposed at a position overlapping the flow path 33A of the protective substrate 30 when viewed in the Z-axis direction, and communicates with the flow path 33A. Further, the flow path 41B is disposed at a position overlapping the flow path 33B of the protective substrate 30 when viewed in the Z-axis direction, and communicates with the flow path 33B. The flow paths 41A and 41B have a recessed shape that opens to a surface of the case 40 facing the +Z direction. Further, the case 40 is provided with a supply port 42 for supplying an ink to the flow path 41A and a discharge port 43 for discharging the ink in the flow path 41B to the outside.

The supply-side common liquid chamber 100A of the present embodiment is configured with the flow path 41A provided in the case 40, the flow path 33A provided in the protective substrate 30, the flow path 19A provided in the pressure chamber substrate 10, and the flow path 121A provided in the communication plate 120. The discharge-side common liquid chamber 100B is configured with the flow path 41B provided in the case 40, a flow path 33B provided in the protective substrate 30, the flow path 19B provided in the pressure chamber substrate 10, and the flow path 121B provided in the communication plate 120. An ink from a liquid storage portion (not illustrated) is supplied to the supply-side common liquid chamber 100A via the supply port 42. The ink in the supply-side common liquid chamber 100A is supplied to the discharge-side common liquid chamber 100B via the absorption chamber 15, the supply-side communication chamber 14, the supply-side throttle portion 13, the pressure chamber 12, the collection path 124, the detection chamber 16, the discharge-side throttle portion 17, the discharge-side communication chamber 18, and the discharge-side communication path 122. The ink in the discharge-side common liquid chamber 100B is discharged from the discharge port 43 to the outside of the liquid ejecting head H.

A substrate constituting each flow path of the supply-side common liquid chamber 100A and the discharge-side common liquid chamber 100B may not be the same as the substrate described in the present embodiment. For example, the protective substrate 30 or the pressure chamber substrate 10 may not cover an entire region of the communication plate 120 in the Y-axis direction, and instead, another substrate having a long length in the Z-axis direction may be provided at both end portions of the communication plate 120 in the Y-axis direction, and a flow path communicating with the flow path 121A and a flow path communicating with the flow path 121B may be formed to penetrate the other substrate in the Z-axis direction.

Further, the case 40 has a through-hole 44 that communicates with the opening portion 32 of the protective substrate 30. The through-hole 44 is provided to penetrate the case 40 in the Z-axis direction. The flexible substrate 110 coupled to the first piezoelectric element 301 and the second piezoelectric element 302 on the diaphragm 50 of the pressure chamber substrate 10 flows out to a surface side of the case 40 facing the -Z direction via the opening portion 32 of the protective substrate 30 and the through-hole 44 of the case 40.

In addition, a supply-side compliance substrate 130A and a discharge-side compliance substrate 130B are provided on a surface of the communication plate 120 facing the +Z direction in which the flow paths 121A and 121B open. In the present embodiment, the supply-side compliance substrate 130A and the discharge-side compliance substrate 130B have the same configuration. Therefore, the supply-side compliance substrate 130A will be described below, but the discharge-side compliance substrate 130B has the same configuration.

In the present embodiment, the compliance substrate 130A includes a sealing film 131 made of a flexible thin film, and a fixing substrate 132 made of a hard material such as metal. A region of the fixing substrate 132 facing the common liquid chamber 100A is an opening portion 133 that is completely removed in a thickness direction, and a surface of the common liquid chamber 100A in the +Z direction is a compliance portion 134 defined only by the sealing film 131. By deforming the compliance portion 134 in this manner, a pressure fluctuation of the ink inside the common liquid chamber 100A can be absorbed and occurrence of a variation in the ejection characteristics such as a flight speed and a weight of the ink droplet ejected from the nozzles 21 can be suppressed.

In the present embodiment, the X-axis direction is an example of an "arrangement direction", the Y-axis direction is an example of an "extending direction", and the Z-axis direction is an example of a "stack direction".

### Other Embodiments

Although one embodiment of the present disclosure is described above, the basic configuration of the present disclosure is not limited to the above description.

For example, in Embodiment 1 described above, the collection path 124 is formed in the recess portion provided in the communication plate 120. However, the present disclosure is not particularly limited thereto, and the collection path 124 may be provided to penetrate the communication plate 120 in the Z-axis direction, may be provided on the pressure chamber substrate 10, or may be provided on both the pressure chamber 12 and the communication plate 120.

In addition, in Embodiment 1 described above, the absorption chamber 15 is continuously provided over the plurality of pressure chambers 12 to form a part of the common supply flow path, but the present disclosure is not particularly limited thereto. For example, the absorption chamber 15 may be provided independently for each pressure chamber 12, and the individual supply flow path may include the absorption chamber 15. In this case, the absorption chamber 15 is included in a portion of the individual supply flow path other than the supply-side throttle portion. In addition, by independently providing a portion of the flow path 121A communicating with the absorption chamber 15, for example, an extension portion extending in the -Y direction of the communication plate 120 and formed in a recessed shape on the surface of the communication plate 120 facing the +Z direction, for each pressure chamber 12, the individual supply flow path may include the extension portion. In this case, the extension portion of the flow path 121A is included in a part of the individual supply flow path other than the supply-side throttle portion. In any case, the individual supply flow path is provided only inside the pressure chamber substrate 10 and the communication plate 120.

In the same manner, in Embodiment 1 described above, the entire flow path 121B constitutes a part of the common discharge flow path, but the present disclosure is not particularly limited thereto. For example, by independently providing a portion of the flow path 121B communicating with the discharge-side communication path 122, for example, an extension portion extended in the +Y direction of the communication plate 120 and formed in a recessed shape on the surface of the communication plate 120 facing the +Z direction, for each pressure chamber 12, the individual discharge flow path may include the extension portion. In this case, the extension portion of the flow path 121B is included in a part of the individual discharge flow path other than the discharge-side throttle portion. In any case, the individual discharge flow path is provided only inside the pressure chamber substrate 10 and the communication plate 120.

In addition, in Embodiment 1 described above, the discharge-side throttle portion 17 is provided downstream opposite to upstream the detection chamber 16, which is the pressure chamber 12 side, but the present disclosure is not particularly limited thereto, and the discharge-side throttle portion 17 may be provided between the pressure chamber 12 and the detection chamber 16. Further, the discharge-side throttle portion 17 may be provided to directly communicate with the pressure chamber 12, and the position of the discharge-side throttle portion 17 is not particularly limited as long as the position is downstream of the pressure chamber 12.

In addition, in Embodiment 1 described above, the supply-side throttle portion 13 is provided at a position that directly communicates with the end portion on the upstream of the pressure chamber 12. However, the present disclosure is not limited to this, and the supply-side throttle portion 13 may communicate with the pressure chamber 12 via another flow path as long as the supply-side throttle portion 13 is on the upstream of the pressure chamber 12.

In addition, in Embodiment 1 described above, the liquid ejecting head H in which the ink circulates is exemplified, but the present disclosure is not particularly limited thereto, and a liquid ejecting head in which the ink does not circulate may be used.

In addition, in Embodiment 1 described above, although the thin film type first piezoelectric element 301 to the third piezoelectric element 303 are used as an energy generation element that generates a pressure change in the pressure chamber 12, the present disclosure is not limited thereto, and for example, a thick film type piezoelectric actuator formed by a method such as attaching a green sheet, a longitudinal vibration type piezoelectric actuator that alternately stacks a piezoelectric material and an electrode forming material and expands and contracts in the axial direction, and the like can be used as the energy generation element. In addition, as the "energy generation element", for example, an element in which a heat generating element is disposed in the pressure chamber 12 to eject a droplet from the nozzle 21 by bubbles generated due to the heat of the heat generating element, a so-called electrostatic actuator that generates static electricity between a diaphragm and an electrode, deforms the diaphragm by the electrostatic force, and ejects the droplet from the nozzle 21, and the like can be used.

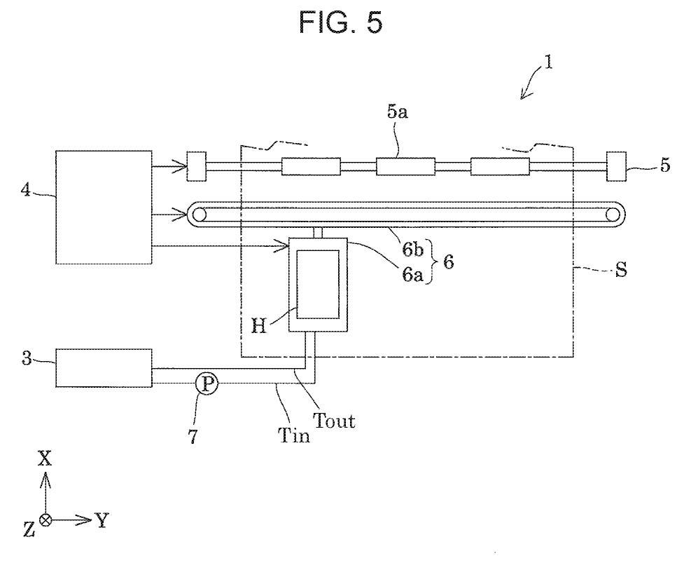

In addition, the liquid ejecting head H of each embodiment described above is mounted on the liquid ejecting apparatus 1. FIG. 5 is a view illustrating a schematic configuration of the liquid ejecting apparatus 1 according to one embodiment of the present disclosure.

As illustrated in the drawing, a liquid ejecting apparatus 1 is a so-called serial printer that includes the liquid ejecting head H and transports a medium S in the X-axis direction, reciprocates the liquid ejecting head H in the Y-axis direction, and performs printing by ejecting a liquid from the liquid ejecting head H toward the medium S in the +Z direction. For the medium S, any material such as recording paper, resin film, or cloth can be used. In addition, a direction in which the liquid ejecting head H reciprocates is not limited to the Y-axis direction, and may be a direction inclined with respect to both the X-axis direction and the Y-axis direction.

The liquid ejecting apparatus 1 includes the liquid ejecting head H, the liquid storage portion 3, the control section 4, a transport mechanism 5 that sends out the medium S, and a movement mechanism 6.

The liquid ejecting head H ejects the liquid supplied from the liquid storage portion 3 as a droplet in the +Z direction.

The liquid storage portion 3 stores the liquid to be ejected from the liquid ejecting head H. The liquid storage portion 3 includes, for example, a cartridge that is attachable and detachable to the liquid ejecting apparatus 1, a bag-shaped ink pack made of a flexible film, an ink tank that can be replenished with the ink, and the like.

A supply tube Tin and a discharge tube Tout are coupled to the liquid storage portion 3.

The supply tube Tin is a tube through which the ink in the liquid storage portion 3, which is pressurized to a predetermined pressure by a pump 7, is supplied to the liquid ejecting head H. The discharge tube Tout is a tube for collecting the ink collected from the liquid ejecting head H to the liquid storage portion 3.

Although not particularly illustrated, the liquid storage portion 3 may be divided into a main tank and a sub-tank. The sub-tank may be coupled to the liquid ejecting head H, and the liquid consumed by ejecting the droplets from the liquid ejecting head H may be replenished from the main tank to the sub-tank.

The control section 4 includes, for example, a control device such as a central processing unit (CPU) or a field programmable gate array (FPGA), and a storage device such as a semiconductor memory. The control section 4 also includes a power supply device that supplies power supplied from an external power supply such as a commercial power supply to each element of the liquid ejecting apparatus 1. The control section 4 is electrically coupled to the liquid ejecting head H via the flexible substrate 110 described above. The control section 4 comprehensively controls each element of the liquid ejecting apparatus 1 by the control device executing a program stored in the storage device.

The transport mechanism 5 transports the medium S in the X-axis direction, and has, for example, a transport roller 5a that rotates by a transport motor controlled and driven by the control section 4.

The movement mechanism 6 is a mechanism for reciprocating the liquid ejecting head H in the Y-axis direction, and includes a holder 6a that holds the liquid ejecting head H, and a transport belt 6b which is an endless belt installed along the Y-axis direction. The control section 4 rotates the transport belt 6b by controlling driving of a transport motor (not illustrated), thereby reciprocating the liquid ejecting head H in the Y-axis direction together with the holder 6a fixed to the transport belt 6b. The liquid storage portion 3 can also be mounted on the holder 6a together with the liquid ejecting head H. The holder 6a holds one liquid ejecting head H, but the holder 6a may hold two or more liquid ejecting heads H.

The liquid ejecting head H performs an ejection operation of ejecting the ink supplied from the liquid storage portion 3 as ink droplets in the +Z direction from each of the plurality of nozzles 21 under the control of the control section 4. The control section 4 functions as an ejection control section that controls ejection of the ink by the liquid ejecting head H. The ejection operation performed by the liquid ejecting head H is performed in parallel with transportation of the medium S in the X-axis direction that is performed by the transport mechanism 5 and reciprocation of the liquid ejecting head H in the Y-axis direction that is caused by the movement mechanism 6, so that so-called printing, in which ink is applied to the medium S, is performed.

In the example illustrated in FIG. 5, the liquid ejecting apparatus 1 is an example in which the liquid ejecting head H is mounted on the holder 6a and moves in the main scanning direction, but the present disclosure is not particularly limited thereto, and the present disclosure can be applied to, for example, a so-called line printer that performs printing by fixing the liquid ejecting head H and moving the medium S in the sub-scanning direction.

Further, the present disclosure is intended for a wide range of liquid ejecting heads and liquid ejecting apparatuses, and can of course be applied to liquid ejecting heads and liquid ejecting apparatuses that eject liquids other than ink. Other liquid ejecting heads include, for example, various recording heads used in image recording apparatuses such as printers, a color material ejecting head used in the manufacture of color filters for liquid crystal displays, an electrode material ejecting head used in the formation of electrodes for organic EL displays, field emission displays (FEDs), and the like, and a bioorganic material ejecting head used in the manufacture of biochips. The present disclosure can also be applied to a liquid ejecting apparatus including such a liquid ejecting head.

### Additional Notes

From the examples illustrated above, for example, the following configurations can be understood.

According to Aspect 1 which is a preferred aspect, there is provided a liquid ejecting head including: a pressure chamber that applies a pressure to a liquid inside the pressure chamber; a nozzle that ejects the liquid by the pressure of the pressure chamber; an individual supply flow path which communicates with the pressure chamber and through which the liquid is supplied to the pressure chamber; an individual discharge flow path which communicates with the pressure chamber and through which the liquid is discharged from the pressure chamber; a supply-side throttle portion provided in a middle of the individual supply flow path; and a discharge-side throttle portion provided in a middle of the individual discharge flow path, in which when a flow path resistance of the pressure chamber is referred to as Rcav, a flow path resistance of the supply-side throttle portion is referred to as Rin_res, a flow path resistance of the discharge-side throttle portion is referred to as Rout_res, a flow path resistance of a portion of the individual supply flow path other than the supply-side throttle portion is referred to as Rin_oth, and a flow path resistance of a portion of the individual discharge flow path other than the discharge-side throttle portion is referred to as Rout_oth, Rcav < Rin_res, Rcav < Rout_res, Rin_oth < Rin_res, and Rout_oth > Rout_res are satisfied.

Accordingly, by providing the supply-side throttle portion and the discharge-side throttle portion, a pressure toward the nozzle in the pressure chamber can be increased and a decrease in ejection characteristics such as a flight speed and a weight of a droplet ejected from the nozzle can be suppressed. In addition, by holding Rin_oth < Rin_res, the flow path resistance of the entire supply-side individual flow path can be reduced, a flow rate of the circulating liquid can be increased, and air bubbles in the pressure chamber or a thickened liquid due to the circulation can be preferably discharged, and recovery performance can be improved. In addition, by holding Rout_oth > Rout_res, a delay in refilling of the ink to the nozzle 21 side can be suppressed without excessively reducing the overall flow path resistance of the individual discharge flow path, and the droplets at a high frequency can be continuously ejected.

According to Aspect 2 which is a specific example of Aspect 1, Rin_oth < 0.5 × Rin_res is satisfied. Accordingly, the effect of Aspect 1 can be more remarkable.

According to Aspect 3 which is a specific example of Aspect 1, Rin_oth > 0.1 × Rin_res is satisfied. Accordingly, a damage to the supply-side throttle portion due to a hydraulic load can be suppressed.

According to Aspect 4 which is a specific example of Aspect 3, Rin_oth > 0.2 × Rin_res is satisfied. Accordingly, the damage to the supply-side throttle portion due to the hydraulic load can be further suppressed.

According to Aspect 5 which is a specific example of Aspect 1, Rout_oth > 2.0 × Rout_res is satisfied. Accordingly, the effect of Aspect 1 can be more remarkable.

According to Aspect 6 which is a specific example of Aspect 1, Rout_oth < 10.0 × Rout_res is satisfied. Accordingly, the effect of Aspect 1 can be more remarkable.

According to Aspect 7, which is a specific example of Aspect 1, Rout_oth < 5.0 × Rout_res is satisfied. Accordingly, an excessive increase of the flow path resistance of the entire individual flow path can be suppressed without excessively increasing the flow path resistance of the portion other than the discharge-side of the individual discharge flow path, and the flow rate of the circulating liquid can be further increased.

According to Aspect 8 which is a specific example of Aspect 1, 0.5 < Rin_res / Rout_res < 2.0 is satisfied. Accordingly, a deviation of a flight direction of the ink droplets from the nozzle 21 can be suppressed and a deviation of a landing position on a recording medium can be suppressed.

According to Aspect 9 which is a specific example of any one of Aspects 1 to 8, one pressure chamber substrate in which the pressure chamber is provided; one nozzle substrate in which the nozzle is provided; and one communication plate located between the pressure chamber substrate and the nozzle substrate are further provided, in which the individual supply flow path is provided only inside the pressure chamber substrate and the communication plate, and the individual discharge flow path is provided only inside the pressure chamber substrate and the communication plate. Accordingly, since the individual supply flow path and the individual discharge flow path can be formed by etching the two substrates of the pressure chamber and the communication plate, the individual supply flow path and the individual discharge flow path can be easily manufactured and formed with high accuracy, and the flow path resistance can be easily controlled.

According to Aspect 10 which is a specific example of Aspect 9, the supply-side throttle portion and the discharge-side throttle portion are provided only inside one of the pressure chamber substrate and the communication plate. Accordingly, by providing the supply-side throttle portion and the discharge-side throttle portion on the same substrate, the supply-side throttle portion and the discharge-side throttle portion can be easily manufactured and formed with high accuracy, and the flow path resistance can be easily controlled.

According to Aspect 11 which is a specific example of Aspect 9 or 10, a plurality of individual flow paths each configured with the individual supply flow path including the pressure chamber, the nozzle, and the supply-side throttle portion, and the individual discharge flow path including the discharge-side throttle portion; a common supply flow path which communicates with the plurality of individual flow paths and through which the liquid is commonly supplied to the plurality of individual flow paths; and a common discharge flow path which communicates with the plurality of individual flow paths and through which the liquid is commonly discharged from the plurality of individual flow paths. are further provided.

According to Aspect 12 which is a specific example of the Aspect 11, when a direction in which the pressure chamber substrate, the nozzle substrate, and the communication plate are stacked is a stack direction, a direction in which the plurality of individual flow paths are arranged is an arrangement direction, and a direction which is orthogonal to the stack direction and the arrangement direction and in which the pressure chamber extends is an extending direction, the pressure chamber is provided between the supply-side throttle portion and the discharge-side throttle portion in the extending direction.

According to Aspect 13 which is a specific example of the Aspect 12, a distance between the pressure chamber and the supply-side throttle portion in the extending direction is shorter than a distance between the pressure chamber and the discharge-side throttle portion in the extending direction. Accordingly, by disposing the discharge-side throttle portion at a position relatively away from the pressure chamber, the liquid in the pressure chamber can be suppressed from easily advancing to the nozzle and disturbance of the ejection characteristics can be suppressed.

According to Aspect 14 which is a preferred aspect, there is provided a liquid ejecting apparatus including: the liquid ejecting head according to any one of Aspects 1 to 13; and a control section that controls an ejection operation of the liquid ejecting head. Accordingly, a decrease in the circulation amount can be suppressed, discharge properties of the air bubbles or the thickened liquid can be improved, and the recovery performance can be improved, and the liquid ejecting apparatus that suppresses the deterioration of the ejection characteristics of the liquid can be realized.

What is claimed is:

1. A liquid ejecting head comprising:
a pressure chamber that applies a pressure to a liquid inside the pressure chamber;
a nozzle that ejects the liquid by the pressure of the pressure chamber;
an individual supply flow path which communicates with the pressure chamber and through which the liquid is supplied to the pressure chamber;
an individual discharge flow path which communicates with the pressure chamber and through which the liquid is discharged from the pressure chamber;
a supply-side throttle portion provided in a middle of the individual supply flow path; and
a discharge-side throttle portion provided in a middle of the individual discharge flow path, wherein
when a flow path resistance of the pressure chamber is referred to as Rcav, a flow path resistance of the supply-side throttle portion is referred to as Rin_res, a flow path resistance of the discharge-side throttle portion is referred to as Rout_res, a flow path resistance of a portion of the individual supply flow path other than the supply-side throttle portion is referred to as Rin_oth, and a flow path resistance of a portion of the individual discharge flow path other than the discharge-side throttle portion is referred to as Rout_oth,
Rcav < Rin_res,
Rcav < Rout_res,
Rin_oth < Rin_res, and
Rout_oth > Rout_res are satisfied.

2. The liquid ejecting head according to claim 1, wherein
Rin_oth < 0.5 × Rin_res is satisfied.

3. The liquid ejecting head according to claim 1, wherein
Rin_oth > 0.1 × Rin_res is satisfied.

4. The liquid ejecting head according to claim 3, wherein
Rin_oth > 0.2 × Rin_res is satisfied.

5. The liquid ejecting head according to claim 1, wherein
Rout_oth > 2.0 × Rout_res is satisfied.

6. The liquid ejecting head according to claim 1, wherein
Rout_oth < 10.0 × Rout_res is satisfied.

7. The liquid ejecting head according to claim 1, wherein
Rout_oth < 5.0 × Rout_res is satisfied.

8. The liquid ejecting head according to claim 1, wherein
80.5 < Rin_res / Rout_res < 2.0 is satisfied.

9. The liquid ejecting head according to claim 1, further comprising:
one pressure chamber substrate in which the pressure chamber is provided;
one nozzle substrate in which the nozzle is provided; and
one communication plate located between the pressure chamber substrate and the nozzle substrate, wherein
the individual supply flow path is provided only inside the pressure chamber substrate and the communication plate, and
the individual discharge flow path is provided only inside the pressure chamber substrate and the communication plate.

10. The liquid ejecting head according to claim 9, wherein
the supply-side throttle portion and the discharge-side throttle portion are provided only inside one of the pressure chamber substrate and the communication plate.

11. The liquid ejecting head according to claim 9, further comprising:
a plurality of individual flow paths each configured with the nozzle, and the supply-side throttle portion, the individual supply flow path including the pressure chamber, and the individual discharge flow path including the discharge-side throttle portion;
a common supply flow path which communicates with the plurality of individual flow paths and through which the liquid is commonly supplied to the plurality of individual flow paths; and
a common discharge flow path which communicates with the plurality of individual flow paths and through which the liquid is commonly discharged from the plurality of individual flow paths.

12. The liquid ejecting head according to claim 11, wherein
when a direction in which the pressure chamber substrate, the nozzle substrate, and the communication plate are stacked is a stack direction,
a direction in which the plurality of individual flow paths are arranged is an arrangement direction, and
a direction which is orthogonal to the stack direction and the arrangement direction and in which the pressure chamber extends is an extending direction,
the pressure chamber is provided between the supply-side throttle portion and the discharge-side throttle portion in the extending direction.

13. The liquid ejecting head according to claim 12, wherein
a distance between the pressure chamber and the supply-side throttle portion in the extending direction is shorter than a distance between the pressure chamber and the discharge-side throttle portion in the extending direction.

14. A liquid ejecting apparatus comprising:
the liquid ejecting head according to claim 1; and
a control section that controls an ejection operation of the liquid ejecting head.
